(19) United States
(12) Patent Application Publication
(10) Pub. No.: US 2014/0019124 A1
(43) Pub. Date: Jan. 16, 2014

(54) USING INFORMATION BANNERS TO COMMUNICATE WITH USERS OF ELECTRONIC DICTIONARIES

(71) Applicant: Abbyy Infopoisk LLC, Moscow (RU)

(72) Inventors: Ivan ARKHIPOV, g. Krasnogorsk (RU); Anna Matveenko, Moscow (RU); Alexander Rylov, g. Krasnogorsk (RU)

(73) Assignee: Abbyy Infopoisk LLC, Moscow (RU)

(21) Appl. No.: 14/032,053

(22) Filed: Sep. 19, 2013

Related U.S. Application Data
(62) Division of application No. 13/430,526, filed on Mar. 26, 2012.
Application No. 13/430,526 is a continuation-in-part of application No. 12/540,184, filed on Aug. 12, 2009, now Pat. No. 8,155,952.
(60) Provisional application No. 61/088,191, filed on Aug. 12, 2008.
(60) Provisional application No. 61/088,199, filed on Aug. 12, 2008.

(51) Int. Cl. G06F 17/27

(52) U.S. Cl. CPC G06F 17/2735
USPC 704/10

(57) ABSTRACT

In one embodiment, computer-implemented systems and methods related to electronic dictionary systems are provided including: storing statistical information representing user interactions with the dictionary system over a period of time and electronically analyzing the statistical information so as to determine a customized message to a user. The customized message may be provided for display as part of a user interface comprising at least one field for entering a dictionary query, at least one field for providing dictionary results, and at least one field for customized user messages.

### PRIORITY

This application is a Continuation-in-part of U.S. patent application Ser. No. 12/540,184 filed on Aug. 12, 2009 which claims the benefit of priority to U.S. Patent Application Nos. 61/088,191 and 61/088,199, both of which were filed on Aug. 12, 2008. The entire specifications of all of the above parent applications are incorporated herein by reference to the extent that they do not conflict with the present disclosure.

### FIELD

Embodiments of the present invention include methods and systems for using search engines, text corpora, and electronic dictionaries.

### BACKGROUND

An electronic dictionary may include a software program supporting the dictionary as well as stored dictionary information. The software program may include a shell, which provides a graphical user interface, morphology models, context searching, a teaching module, and other features. A dictionary may comprise separate units which may include text or compiled files.

The dictionary software program may be installed locally on a user's computer, remotely on a server connected by a local area network or by a wide area network such the Internet. The dictionaries may be independently stored in different locations.

### SUMMARY

In one embodiment, the system provides a method, comprising: receiving one or more queries from a user computer device; determining what custom messages are applicable based on such one or more queries; and delivering any applicable custom messages to the user computer device. The invention is not limited to a specific system configuration. In one embodiment the system uses client-server architecture with certain functions running locally at a user computer device and other functions performed at one or more servers. In other embodiments all the functions are performed at a server level and the user device interfaces with a software application using, for example, an internet browser or the like. Conversely, all the capabilities may be performed locally by the user computer device. It should be understood that a server means one or more servers, including various distributed architectures. A user device may be any device with which the user interacts including a personal computer, handheld device, a tablet, or another device.

The custom messages may be selected and customized by a server device based on one or more customization control parameters. In one embodiment, the customization control parameters may include the interface language, the regional settings, the version of the product, statistical data about user's search queries and statistics concerning user's interaction with the user interface.

Trial or custom versions of dictionaries may provide the messages that are different from the messages in paid or non-trial versions. For example, for a trial version, a warning message may be sent informing the user that the trial period is about to expire. Additionally, the server device has the capability to detect whether the version used by a user is a bootleg copy and send customized messages to users of bootleg versions.

### BRIEF DESCRIPTION OF THE DRAWINGS

FIG. 1 shows a high-level block diagram of a network configuration of one embodiment.

FIG. 2 shows a graphical user interface (GUI) that facilitates local and online dictionary searches, in accordance with one embodiment.

FIG. 3 shows the search control panel of the GUI of FIG. 2 in greater detail.

FIG. 4 shows a flowchart of dictionary software delivering a custom message in response to a query.

FIG. 5 shows a flowchart of operations performed by one embodiment of dictionary software in order to create and deliver custom messages based on information about a user.

FIG. 5A shows a more detailed flowchart of creating and delivering custom messages based on information about the user.

FIG. 6 shows exemplary computer architecture for implementing a user computer device or a server device, in accordance with one embodiment.

### DETAILED DESCRIPTION

The system of one embodiment includes a dictionary system that allows a user to obtain translations from additional sources, e.g. additional dictionaries. For example, if the user has not found a suitable translation based on a first search of available dictionaries, the user may click on a link and obtain search results from additional dictionaries. The user can customize the list of additional dictionaries in accordance with user's preferences.

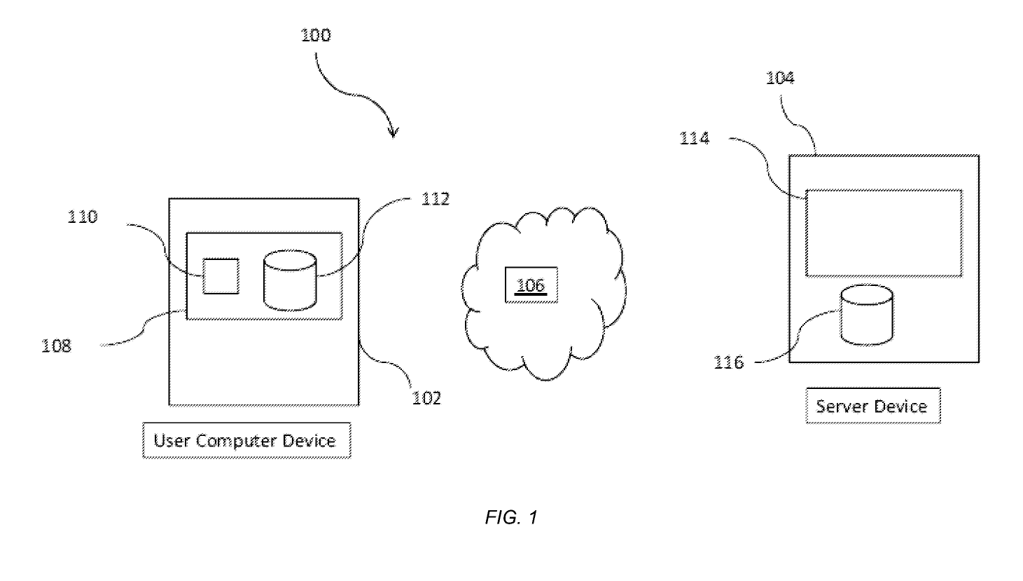

FIG. 1 shows a network configuration 100 for invention client-server embodiment. The network configuration 100 comprises a user computer device 102 that is coupled to a server device 104 via network 106. The network 106 may comprise a local area network (LAN) or a wide area network (WAN) such as the Internet.

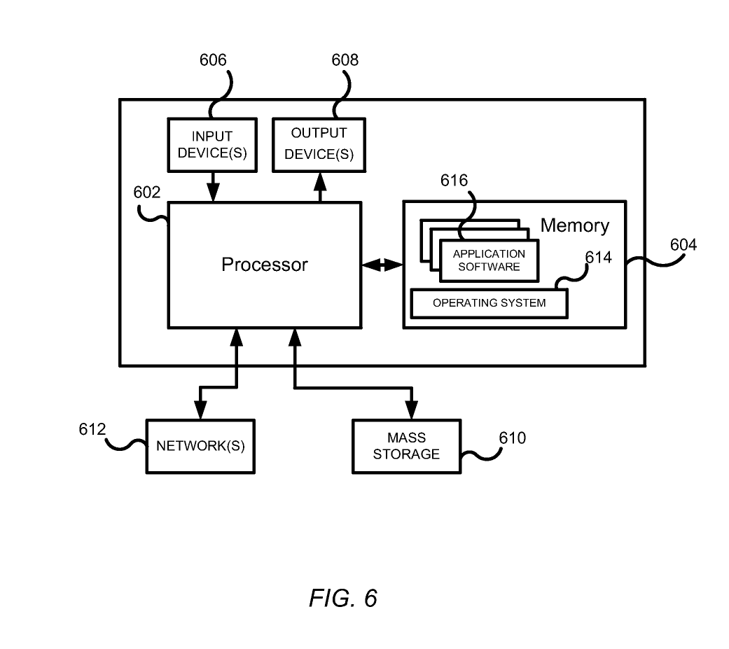

The user computer device 102 may comprise a general purpose computer, such as a desktop personal computer (PC), a laptop computer, a tablet device, a mobile hand-held device, or another computing device. FIG. 6 includes exemplary hardware for implementing the user computer device 102 in accordance with one embodiment.

The user computer device 102 may include application 108 comprising a dictionary shell 110 and one or more local dictionaries 112. The server device 104 may also be implemented using the hardware of FIG. 6. In one embodiment, the server device 104 may be provided with server dictionary software 114. It may also be provided with one or more remote or online dictionaries 116.

As noted, while client-server configuration is discussed here, in another embodiment the capabilities may be differently allocated among the system components, including entirely cloud-based applications and local hand-held products.

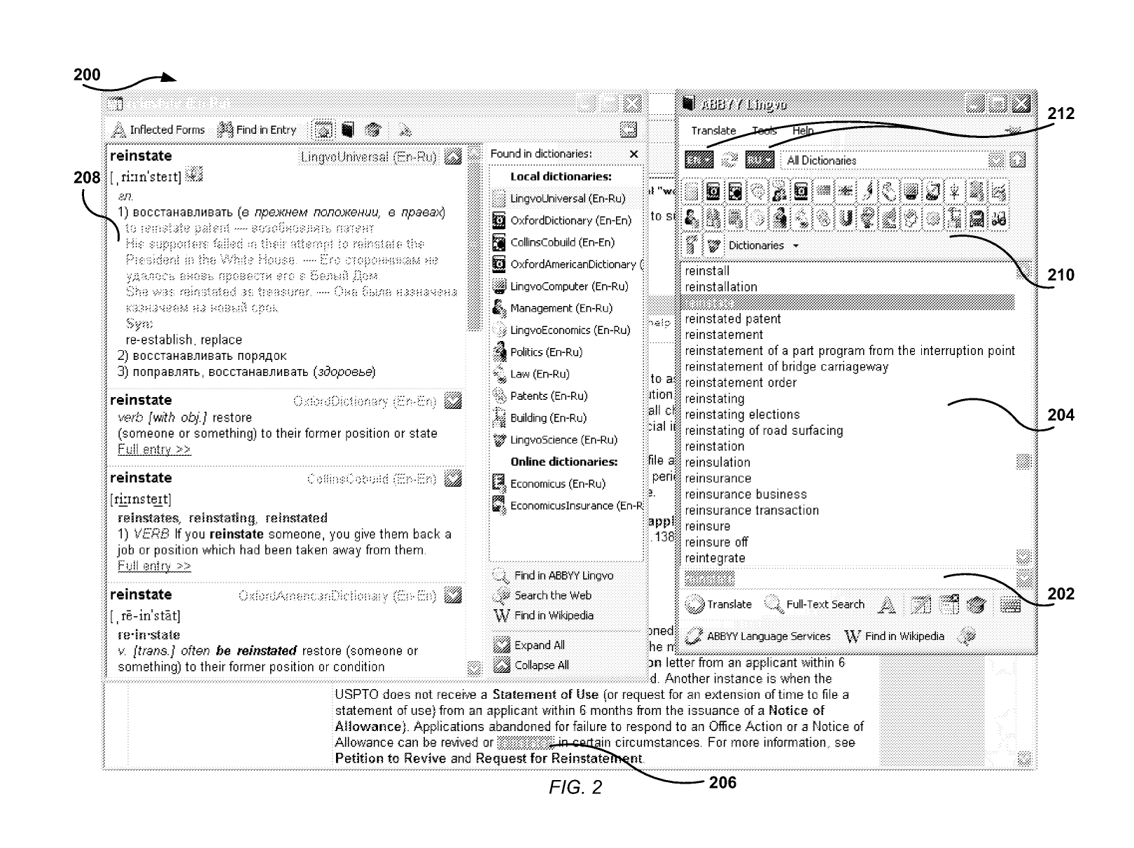

The dictionary shell 110 may provide a graphical user interface (GUI) to facilitate searching of the local and online dictionaries. One embodiment of the GUI 200 is illustrated in FIG. 2. The GUI comprises a search entry window 202, where a user can enter one or more words defining a query. The GUI 200 may also allow the user to select words for a word list 204. In one embodiment, the user may select a word 206 in a document, so as to define a dictionary query. One or more dictionary entry windows 208 may be opened if the word is found in local or online dictionaries.

The local and online dictionaries that can be accessed with the application 108 may be presented as a bookshelf 210 for a selected pair 212 of languages. The bookshelf 210 comprises icons, each representing a particular dictionary, e.g. “Auto”, “Accounting”, “Computers”. In one embodiment, only the dictionaries whose icons are displayed on the bookshelf 210 may be used for translation. In other embodiments search results from other sources may be offered to the user. In some embodiments, a user may be allowed to choose a bookshelf from a drop-down list of bookshelves. Available bookshelves may, for example, include “All Dictionaries,” “General Dictionaries,” “Science Dictionaries.” A user may disable any dictionary on the bookshelf 210 by clicking on its icon. A disabled dictionary is not used in translation or search even though it is shown on the bookshelf 210. Icons corresponding to disable dictionaries are distinguished visually e.g., in one embodiment, they are “grayed out.” The same dictionary may be placed on several bookshelves. Enabling or disabling a dictionary on one bookshelf does not affect its status on other bookshelves.

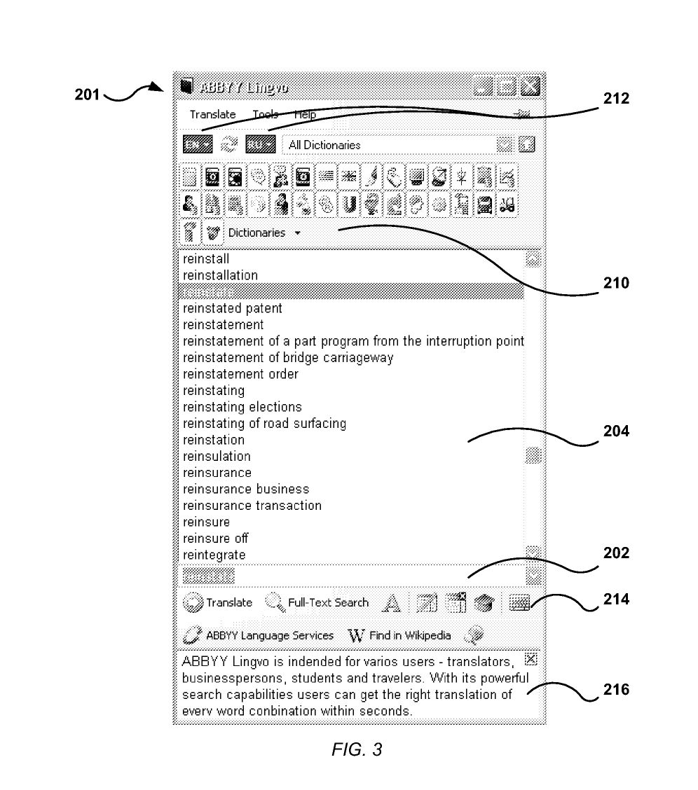

FIG. 3 illustrates in more detail a search control panel 201 of GUI 200. In one embodiment, it may include a toolbar 214 to control search parameters such as a parameter specifying whether all word-forms of a word are required, a parameter specifying whether the entire text of a dictionary is to be searched, a parameter specifying whether to start a tutor, as well other parameter specifying other capabilities. An information banner 216 may be used to communicate information to the user.

The user enters a search string or a query comprising one word or a combination of words using any of the input methods provided by the GUI 200. As noted, the control panel of GOU 200 is illustrated as 201 in FIG. 3. As indicated, the GUI 200 provides a search entry window 202, wherein a search string may be entered. The GUI 200 also provides a word list 204 so that the user can select a word therefrom to include it in the search string. Further, the GUI 200 allows for a word to be selected from a text in a document.

In response to the entered search string, the client dictionary application 108 performs a search (also “first search”) of at least one source (also “first source”) for information responsive to a query. The first source may comprise the local dictionaries 112. The result of the first search may be displayed in one or more dictionary windows 208 (See FIG. 2. If the user is dissatisfied with the search result, the user can instruct the client dictionary application 108 to perform another search (also “second search”), using the GUI 200 in the manner described above. This latter or second search is of additional dictionaries. The additional dictionaries may comprise various kinds of dictionaries including translation dictionaries, monolingual dictionaries, specialized dictionaries, and other known dictionaries. Additionally, usage examples available in other intranet or Internet resources, such as, text corpora, TM-bases, forums, online-encyclopedias and other resources, may be searched. For translation dictionaries, a translation direction (i.e. the source and the target languages) may be established either explicitly or implicitly using the GUI 200.

In accordance with one embodiment, there may be at least two ways in which additional dictionaries may be located using the server 104. First the shell 110 may “know” about a dictionary. In this case, a link to the dictionary is stored in the shell and may be activated by the shell 110 either automatically or optionally. This type of a remote dictionary is termed “connected.” In addition, a dictionary may simply be located on or through the server 104 without local information about the dictionary. This type of a remote dictionary is termed “not connected.” Both connected and not connected dictionaries may be stored on the server or on another computer accessible to the server over a network, for example, the Internet.

In one embodiment, a user may immediately obtain translations and definitions found both in the locally-installed dictionaries and in the online dictionaries. If no entries are found in the local dictionaries, the entries from the online dictionaries are displayed. Entries from online dictionaries may be shown in the same window as from the local dictionaries or in separate windows.

In one embodiment, entries from additional dictionaries may be shown as a link which allows the user to see these entries. The additional translations, which are found in the “not connected” dictionaries may be shown by a link which, for example, states “7 more (online entries)>>.” When the user selects such a link, additional translations or definitions are downloaded into the dictionary window of GUI. In another embodiment, the user may set up the shell so as to obtain translations from the online dictionaries only upon clicking an appropriate link (e.g. “view entries from online dictionaries”).

In still another embodiment, the number of lookups in the “not connected” dictionaries may be restricted. For example, the user may have a restricted number of free connections and the user would need to make a payment to permanently connect a dictionary or another condition may be imposed on the usage of “not connected” dictionaries. Each dictionary on the server may be provided with a counter, which controls the number of free dictionary lookups available to a user. Once the number of free lookups has been used up, the user would still be informed that the dictionary contains the requested word, but the user would need to connect this dictionary to the shell in order to view the entry.

In still another embodiment, a dictionary may be advertised. In this case, together with the translations from the connected online dictionaries, the user would also obtain translations from an advertised dictionary, which counter would be disabled for a certain time period for promotional purposes. The entries from the advertised dictionary may include a small advertising banner with a link to a website with detailed information about the dictionary. In still another embodiment, the additional dictionary may be free and/or created by a user. An additional dictionary may be offered based on the language of the interface, regional settings, and other parameters. Additional dictionaries may be created for restricted user groups and may be downloaded depending on user's rights. There may be online-dictionaries that can be enriched by users directly.

When connecting a dictionary to the shell, the user may select an installation method: the dictionary may be downloaded and installed locally or it may be used remotely as an online dictionary, i.e. the shell would need to access the server to obtain entries from this dictionary. The shell may also display a catalog of dictionaries located on the server and updated at regular intervals so that the user may see information about dictionaries without visiting the corresponding websites, add words from the online dictionaries to the wordlist (the list of entries from one or more dictionaries), and display the found translations when the user points to a word on the display.

The described embodiments provide the user with additional search results from online dictionaries and may also be viewed as a mechanism for selling dictionary content. A dictionary may be advertised or it may be offered when the user needs to look up words in it, such as, when there is a matching language pair and entry.

Additionally, the use of online dictionaries greatly reduces the size of distribution packages. For example, when a user decides to download a trial version, the size of the distribution package matters. In still another embodiment, the distribution package may include only online dictionaries which the user may download at a later stage if required. Additionally, the user may separately download sound and media files, morphological dictionaries and application resources required for localization. In other embodiments, the user can use dictionaries as cloud applications so that the local device would be used to provide an internet browser.

In one embodiment, users receive custom messages. The messages may be customized based on a type of a license under which the dictionaries have been provided, the dictionaries that have been used by the client dictionary application 108, as well as using other parameters.

Referring to FIG. 3, the information banner 216 may be used for displaying custom messages sent by the server device 104 to the user. These messages may include tips, advertising messages, informational messages, and the like. A message may be in the form of a link to a website that contains more information. In one embodiment, the user may close the banner 216, in which case the banner will be displayed again whenever a new message is delivered by the server 104. The user may be allowed to disable the banner 216, in which case it is not displayed again.

The messages provided to the user may be selected and customized based on one or more customization control parameters. In one embodiment, the customization control parameters may include the interface language, the regional settings, the version of the product, statistical data about user's search queries, and statistical data about user's interaction with the shell interface. For example, during a given time interval, a general theme of user's queries has been identified as relating to the sports. In this case, a message provided to the banner 216 may contain information about a dictionary of sport's terms or an advertisement of sporting goods. In forming a message the system can also take into account user's language and regional settings.

A custom message may also suggest to a user certain features and capabilities of the system. For example, if a user has not used the full-text search feature, which may help him/her to see word usage or a word combination absent in the word list of a dictionary, the corresponding custom message may suggest using such a feature. A custom message may be used to improve user's interaction with the interface, particularly, when the interface provides useful controls underutilized by the user. For example, depending on how a given interface button has been used, the system may provide information as part of the message regarding the usage and advantages of the particular button.

In one embodiment, messages provided to the user are independent from user's expertise in using the system—the same advice is provided to an experience and a new user. In another embodiment, users may be categorized based on their experience in using the dictionary system interface or the amount and variety of search queries that they have executed, so that the system would adjust the messages to user's experience. A user may post his/her experience with the system to a social network so that the server identifies this information and adjusts the messages accordingly.

Trial versions of dictionaries may have messages that differ from the messages provided in paid or non-trial versions. For example, in the trial versions, a warning message may be sent informing the user that the trial period is about to expire. Additionally, the server 104 has the capability to detect whether the version used by a user is bootleg or not, and send customized messages to users of bootleg versions.

As discussed above, the information banner 216 may be used to display tips and advice on working with the product. It may also be used to inform the user about new dictionaries, releases, or related products, and to organize competitions and polls. Additionally, the information banner 216 may be used to communicate to the users of the trial versions the benefits of corresponding non-trial versions. The information banner 216 may contain graphics, sound, and other media files, e.g., pictures, sound files, Flash content.

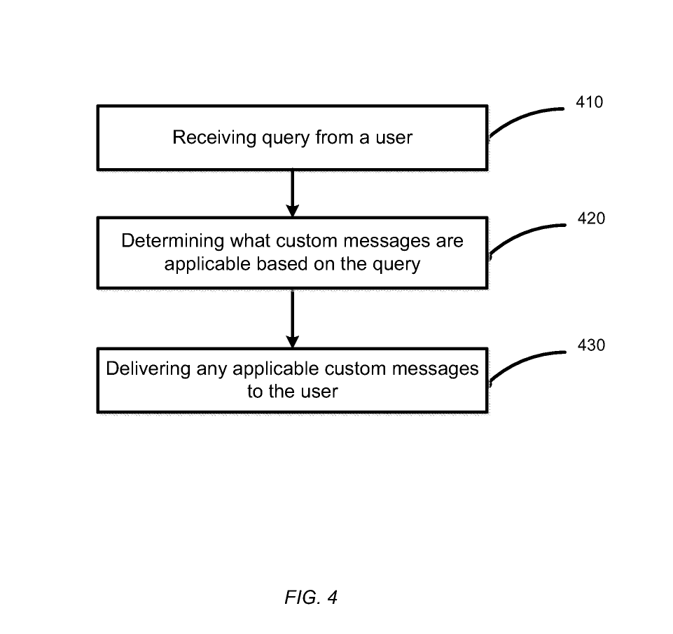

FIG. 4 shows a flowchart of operations which may be performed by the client dictionary software 108 and/or by the server dictionary software 114 in order to deliver and to display the custom messages to a user. Referring to FIG. 4, at block 410, the client dictionary application 108 receives a query from a user. At block 420, in one embodiment, the client dictionary software determines what custom messages are applicable based on the search query. In another embodiment, the client dictionary software sends the query to the server 104, and the server dictionary software determines what custom messages are applicable based on the search query. Then, one of the applicable custom messages is returned to the client dictionary software. Applicable custom messages may be selected or generated based on the interface language, regional settings, product version, and also based no statistical data about user's search queries and statistical data about user's interaction with the shell interface. Statistical data and other user-related information may be collected and saved on the user computer device 102, and/or on the server 104. At block 430, the client dictionary application 108 delivers an applicable custom messages to the user on the informational banner 216.

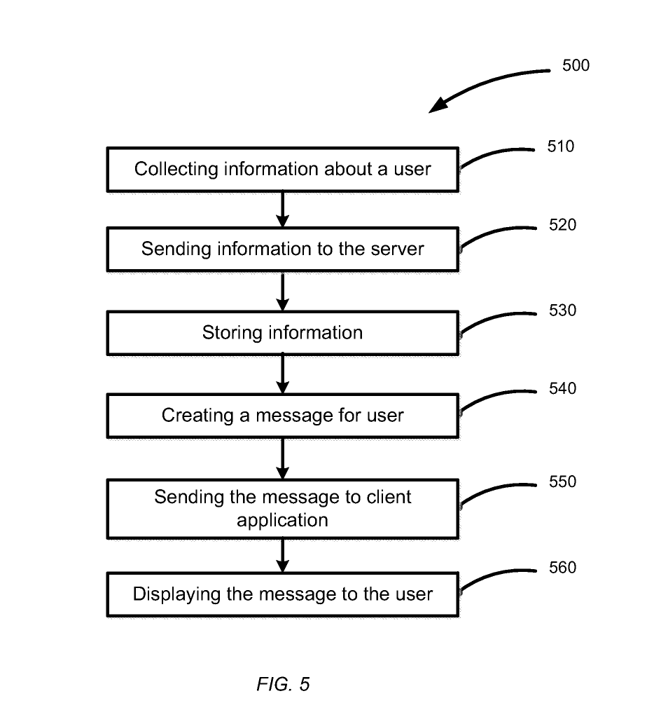

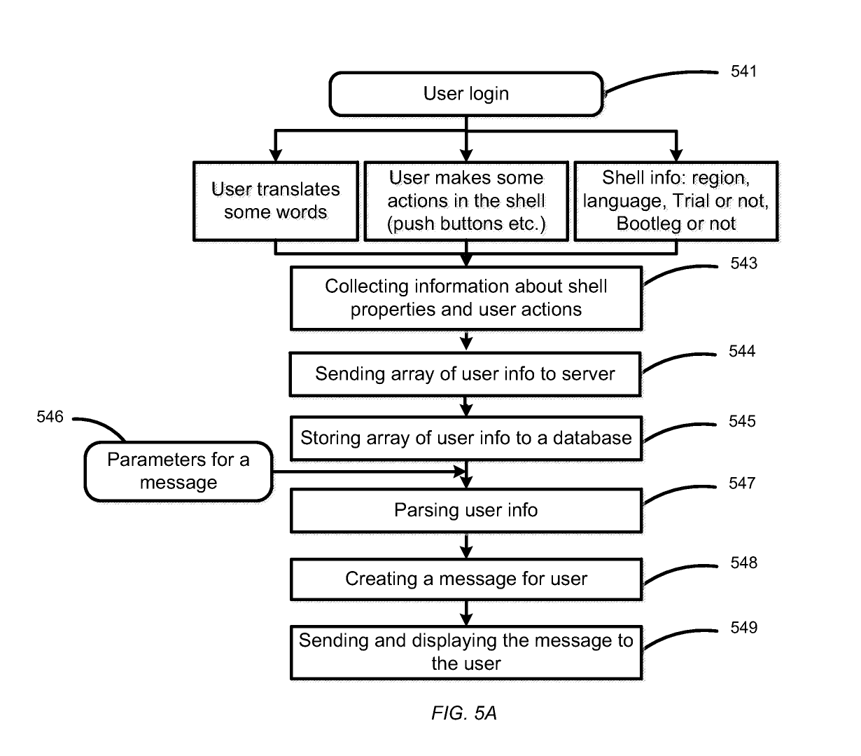

FIG. 5 shows a flowchart of operations performed by the local user device and/or server dictionary software 114. While client-server configuration is primarily discussed, the system can be implemented using other configurations, including cloud-based. The system collects information about a user, statistical data about user's search queries, statistical data about user's interactions with the shell interface, and creates and delivers custom messages to the user. Referring to FIG. 5, at block 510, information about a user is collected. Client dictionary application 108 and/or server dictionary application 114 register actions and queries of the user and hold information about user's settings provided, for example, at the user computer device 102.

From time to time, the client dictionary application 108 sends user-related information to the server 104 as illustrated in block 520. The information about the user and his/her actions, queries and user settings is then stored (block 530) and saved by the server dictionary software 114. Also from time to time the server application 114 creates (block 540) a custom message based on analyzing of the stored user information. The exemplary steps of collecting and analyzing information as well as creating custom messages are shown on FIG. 5A. The selected custom message is sent (block 550) to the client application 108 for displaying (block 560) the message to the user.

Referring to FIG. 5A, after user logs in (block 541), the server application 114 can identify the user and register all his/her actions and queries. In interacting with the client dictionary application 108, the user translates words and executes operations, for example, the user pushes buttons of the interface, enables and disables dictionaries, selects languages, uses a tutor program, and conducts other interactions with the interface. The server application 114 also stores information concerning the shell, such as the settings of the region and language, information concerning whether the current version is a trial one or not, and information relating to whether it is a bootleg version. Such information about shell properties and user actions is collected locally (block 542) and an array of user information is transmitted (block 543) to the server. The array of user information is then stored (block 544) to a database at the server.

From time to time, the server application 114 parses the user information stored in the database of the server. In one embodiment, parsing 547 may use several criteria, for example, the user location and language, user's interface experience, such as a number of times a given interface feature has been activated or which features have not been utilized. For example, the system may identify an underutilized capability if the user does not use a given interface button, which may provide valuable assistance to user's interactions. The parsing subsystem may be set up so that if the user pushes a given interface button less than a certain number of times, then the system should provide advice concerning the usage of the button.

Also, in one embodiment, the parsing subsystem may identify a subject that is the most interesting for a user. Based on user's interest, a helpful message or a targeted advertisement may be provided. For example a sports dictionary available in the US may be advertised to a US user who often looks up sports terms. The parsing subsystem first determines user's location, and then user's subjects of interest, based on the terms that have been translated. As noted, if the primary subject of translations has been determined to relate to sports, the server application 114 may form a message advertising sports-related goods. Various methods, including the simpler ones, such as heuristics, and the more complex ones, such as classifying, may be used for determining a subject based on the history of searchers.

As shown on FIG. 5A, several parameters (block 546), used for creating a message, are specified in the system. In one embodiment, such parameters may include the message language and the message type, which maybe advertisement or advice about the interface. After the message type has been defined and the message was created, it is sent to the user's computer and displayed (block 549).

FIG. 6 includes hardware that may be used to implement the user computer device 102 or the server 104. The hardware typically includes at least one processor 602 coupled to a memory 604. The processor 602 may represent one or more processors (e.g. microprocessors), and the memory 604 may represent random access memory (RAM) devices comprising a main storage of the shown hardware, as well as any supplemental levels of memory, e.g., cache memories, non-volatile or back-up memories (e.g. programmable or flash memories), read-only memories, and the like. In addition, the memory 604 may be considered to include memory storage physically located elsewhere in the hardware, e.g. any cache memory in the processor 602 as well as any storage capacity used as a virtual memory, e.g., as stored on a mass storage device 610, or as distributed memory.

The hardware of FIG. 6 also typically receives a number of inputs and outputs for communicating information externally. For interfacing with a user or operator, the hardware of FIG. 6 may include one or more user input devices 506 (e.g., a keyboard, a mouse, imaging device, scanner, etc.) and a one or more output devices 608 (e.g., a Liquid Crystal Display (LCD) panel, a sound playback device (speaker).

For additional storage, the hardware 600 may also include one or more mass storage devices 610, e.g., a removable disk drive, a hard disk drive, a Direct Access Storage Device (DASD), an optical drive (e.g. a Compact Disk (CD) drive, a Digital Versatile Disk (DVD) drive, etc.) and/or a tape drive, among others. Distributed storage may also be used. Furthermore, the hardware may include an interface with one or more networks 612 (e.g., a local area network (LAN), a wide area network (WAN), a wireless network, and/or the Internet among others) to permit the communication of information with other computers coupled to the networks. It should be appreciated that the hardware of FIG. 6 typically includes suitable analog and/or digital interfaces between the processor 602 and each of the components 604, 606, 608, and 612 as is known in the art.

The hardware of FIG. 6 operates under the control of an operating system 614, and executes various computer software applications, components, programs, objects, modules, etc. to implement the techniques described above. In particular, the computer software applications include the client dictionary application 108, in the case of the client user device 102, and the server dictionary software, in the case of the server 104. Moreover, various applications, components, programs, objects, etc., collectively indicated by reference 616 in FIG. 6, may also execute on one or more processors in another computer coupled to the hardware of FIG. 6 via a network 612, e.g., in a distributed computing environment, whereby the processing required to implement the functions of a computer program may be allocated to multiple computers over a network.

In general, the routines executed to implement the embodiments of the invention may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processors in a computer, cause the computer to perform operations necessary to execute elements involving the various aspects of the embodiments. Moreover, while the embodiments have been described in the context of fully functioning computers and computer systems, those skilled in the art will appreciate that the various embodiments of the invention are capable of being distributed as a program product in a variety of forms, and that the invention applies equally regardless of the particular type of computer-readable media used to actually effect the distribution. Examples of computer-readable media include but are not limited to recordable type media such as volatile and non-volatile memory devices, floppy and other removable disks, hard disk drives, optical disks (e.g., Compact Disk Read-Only Memory (CD-ROMs), Digital Versatile Disks (DVDs), flash-memory etc.), among others. The other type of distribution may be downloading files from an internet-site. In addition the entire application may be cloud-based.

While certain exemplary embodiments have been described and shown in the accompanying drawings, it is to be understood that such embodiments are merely illustrative and not restrictive of the broad invention and that this invention is not limited to the specific constructions and arrangements shown and described, since various other modifications may occur to those ordinarily skilled in the art upon studying this disclosure.

1.-20. (canceled)

21. A dictionary system, comprising:
a processor configured to:
store, in a memory, query information representing a plurality of queries issued by a user to the dictionary system over a period of time;
analyze the query information to determine a subject of interest to the user;
identify a product or service consistent with the subject of interest; and
provide an advertising message advertising the product or service, wherein the advertising message is configured to be part of a user interface comprising:
a field for entering a dictionary query;
a field for providing dictionary results;
a field for providing customized messages; and
a representation of a collection of dictionaries where the user may perform a search.

22. The system of claim 21, wherein the product or service is an electronic dictionary.

23. The system of claim 21, wherein the processor is further configured to store, in the memory, interface information representing a plurality of user interactions with the dictionary system over a period of time.

24. The system of claim 23, wherein the processor is further configured to:
analyze the stored interface information to determine whether there is an interface feature that could be better utilized; and
responsive to determining the interface feature that could be better utilized, provide information for the user regarding utilizing the interface feature.

25. The system of claim 23, wherein the processor is further configured to:
categorize an experience level of the user based on at least one of the stored interface information and the stored plurality of queries issued by the user; and
generate a customized message based on the experience level of the user

26. The system of claim 21, wherein the processor is further configured to generate a customized message based on at least one of an interface language of the electronic dictionary, a regional setting of the electronic dictionary, and a product version of the electronic dictionary.

27. The system of claim 21, wherein the subject of interest is based on a term that has been translated from a first language to a second language, and wherein the query information includes the term that has been translated.

28. A method, comprising:
storing, in a memory, query information representing a plurality of queries issued by a user to a dictionary system over a period of time;
analyzing, by a processor, the query information to determine a subject of interest to the user;
identifying, by the processor, a product or service consistent with the subject of interest; and
providing, by the processor, an advertising message advertising the product or service, wherein the advertising message is configured to be part of a user interface comprising:
a field for entering a dictionary query;
a field for providing dictionary results;
a field for providing customized messages; and
a representation of a collection of dictionaries where the user may perform a search.

29. The method of claim 28, wherein the product or service is an electronic dictionary.

30. The method of claim 28, further comprising storing, in the memory, interface information representing a plurality of user interactions with the dictionary system over a period of time.

31. The method of claim 30, further comprising:
analyzing the stored interface information to determine whether there is an interface feature that could be better utilized; and
responsive to determining the interface feature, providing information for the user regarding utilizing the interface feature.

32. The method of claim 30, further comprising:
categorizing an experience level of the user based on at least one of the stored interface information and the stored plurality of queries issued by the user; and
generating a customized message based on the experience level of the user.

33. The method of claim 28, further comprising generating a customized message based on at least one of an interface language of the electronic dictionary, a regional setting of the electronic dictionary, and a product version of the electronic dictionary.

34. The method of claim 38, wherein the subject of interest is based on a term that has been translated from a first language to a second language, and wherein the query information includes the term that has been translated.

35. A non-transitory computer-readable medium having instructions stored thereon, the instructions comprising:
instructions to store, in a memory, query information representing a plurality of queries issued by a user to a dictionary system over a period of time;
instructions to analyze the query information to determine a subject of interest to the user;
instructions to identify a product or service consistent with the subject of interest; and
instructions to provide an advertising message advertising the product or service, wherein the advertising message is configured to be part of a user interface comprising:
a field for entering a dictionary query;
a field for providing dictionary results;
a field for providing customized messages; and
a representation of a collection of dictionaries where the user may perform a search.

36. The non-transitory computer-readable medium of claim 35, wherein the product or service is an electronic dictionary.

37. The non-transitory computer-readable medium of claim 35, further comprising instructions to store, in the memory, interface information representing a plurality of user interactions with the dictionary system over a period of time.

38. The non-transitory computer-readable medium of claim 37, further comprising:
instructions to analyze the stored interface information to determine whether there is an interface feature that could be better utilized; and
instructions to provide information for the user regarding utilizing the interface feature, responsive to determining the interface feature.

39. The non-transitory computer-readable medium of claim 37, further comprising:
instructions to categorize an experience level of the user based on at least one of the stored interface information and the stored plurality of queries issued by the user; and
instructions to generate a customized message based on the experience level of the user.

40. The non-transitory computer-readable medium of claim 35, further comprising instructions to generate a customized message based on at least one of an interface language of the electronic dictionary, a regional setting of the electronic dictionary, and a product version of the electronic dictionary.
